(19) United States
(12) Patent Application Publication
(10) Pub. No.: US 2004/0222946 A1
(43) Pub. Date: Nov. 11, 2004

(54) Three-dimensional display device

(76) Inventors: Hiromichi Noguchi, Tokyo (JP); Takahisa Igarashi, Soka-shi (JP)

Correspondence Address: Steven J. Grossman, Grossman, Tucker, Perreault & Pfleger, PLLC, 55 South Commercial Street, Manchester, NH, 03101, US

(21) Appl. No.: 10/838,096

(22) Filed: May 3, 2004

(30) Foreign Application Priority Data
May 7, 2003 (JP) U 2003-002552
Mar. 19, 2004 (JP) U 2004-001418

(51) Int. Cl. G09G 5/00

(52) U.S. Cl. 345/6

(57) ABSTRACT

A three-dimensional display device includes a frame and plural support portions held by the frame, the support portions for holding objects to be displayed.

### BACKGROUND OF THE INVENTION

1. Field of the Invention

The present invention relates to a three-dimensional display device capable of three-dimensionally holding display sheets such as photographs, postcards, paintings, cutouts, and the like.

The present application claims priority on Japanese Utility Model Application No. 2003-2552 filed on May 7, 2003, and Japanese Utility Model Application No. 2004-1418 filed on Mar. 19, 2004, the contents of which are incorporated herein by reference.

2. Description of the Related Art

In general, a photo-stand, generally known as a conventional display sheet appreciation stand, has a two-dimensional photograph sandwiched between a transparent top panel and a rear panel, and is held in a frame. However, such a photo-stand has a problem in that only two-dimensional viewing is possible.

In contrast to this, several proposals have been made in the past for three-dimensional photo-stands, which makes it possible to enjoy a photograph three-dimensionally.

For example, a three-dimensional photo-stand according to the device disclosed in Japanese Utility Model Laid-Open No. 5-58079 is constituted by a convex transparent top panel protruding at the front side, a convex photo-panel in which a photo is formed (of printed) on a panel disposed at the rear side of the convex transparent top panel and protruding at the front side, and a picture frame in which these transparent top panel and photo-panel are fitted and fixed. Furthermore, there is also disclosed a three-dimensional photo-stand, which is constituted by a convex-transparent top panel, a convex transparent photo-presser protruding at the front side, a convex presser back board having the same curvature as that of this convex transparent photo-presser, and a frame in which the transparent photo-presser in a state of sandwiching a photograph and the presser back board are disposed at the rear side of the transparent top panel, and the transparent top panel, the transparent photo-presser, and the presser back board are sandwiched and fixed. Although the three-dimensional photo-stand disclosed in this publication is such that one of the photographs protrudes at convexly so that it can be seen three-dimensionally, it allows only one of the photographs to be appreciated, and therefore, it is unintresting.

Furthermore, the three-dimensional photo-stand according to the invention disclosed in Japanese Patent Laid-Open No. 7-204068 comprises a case having a top panel provided with a lens at a window hole portion, and comprises in the front side of the pocket portion a biasing member for biasing plural photographs stored in a pocket portion of the backside of the top panel from the backside, and an engaging portion for controlling the photograph positioned in the forward side of the top panel to a position spaced apart at a predetermined distance from a lens surface. According to this three-dimensional photo-stand, the photograph positioned in the forward side is seen through the lens, thereby magnifying the photograph. However, although plural photographs can be stored in the pocket portion, the photograph which can be seen all at once is, first and foremost, only the photograph disposed at the front portion, and therefore, there is a problem in that it is uninteresting.

In contrast to this, the three-dimensional photo-stand according to the device disclosed in Japanese Utility Model Laid-Open No. 2-74860 provides a background photo-stand, and a small transparent photo-stand in front of the background photo-stand. Although the background photo-stand and the front photo-stand are positioned respectively by a mounting board, and this constitution is such that plural photo-stands are constituted integrally by the mounting board, and therefore, it becomes bulky and is not suitable for hand-carrying. In addition, there is a problem in that a positional relationship between the photograph inserted in the front photo-stand and the photograph inserted in the background photo-stand has no degree of freedom.

Furthermore, a sheet-shaped appreciative item appreciative combination body according to the device disclosed in Japanese Utility Model Registration No. 3013148 comprises a holding fixture for holding the sheet-shaped appreciative item such as a picture postcard and the like, and holds the sheet-shaped appreciative item by the holding fixture so as to curve it concavely. Furthermore, by placing a three-dimensional appreciative item at a predetermined position opposed to the sheet shaped appreciative item, a concavely curved sheet-shaped appreciative item and the three-dimensional appreciative item placed in front thereof can be appreciated at once. However, according to this constitution, the three-dimensional appreciative item is fixed by bonding to a predetermined position on a three-dimensional appreciative item positioning means comprising a thin board fitted into a gap between the sheet-shaped appreciative item and a front wall of the holding fixture. Consequently, the three-dimensional appreciative item can be positioned only on the three-dimensional appreciative item positioning means, and therefore, there is a problem in that a relative positional relationship between the sheet-shaped appreciative item and the three-dimensional appreciative item has no degree of freedom.

Furthermore, the three-dimensional photo-stand according to the device disclosed in Japanese Utility Model Laid-Open No. 5-88999 stacks, in order, a transparent first intermediate panel, an intermediate recent partial photograph, a second intermediate panel, a foremost recent photograph, and a transparent front panel on a rear whole photograph, all of which are fitted into a frame body in a stacked state, and a picture frame is detachably mounted on the front portion of the frame body. However, according to this constitution, the transparent first and second intermediate panels, the front panel, and plural photographs are all superposed one upon another. Consequently, it is not easy to superpose the photographs so that they do not slip out of place. Furthermore, when replacing the intermediate photograph, it is difficult to take out and replace the intermediate photograph alone, and the superposing operation of all the photographs and panels must be performed again. This causes a problem in that it takes a lot of work. Furthermore, since a gap between the preceding intermediate recent partial photograph and the whole photograph is maintained by the first thick intermediate panel to ensure a spacing, in order to make the spacing large so as to exhibit a three-dimensional effect, the panel is thick, and the influence of refraction becomes high. This causes a problem in that the spacing cannot be made too large.

Furthermore, in the case in which the display sheets such as plural photographs and the like are superposed and disposed in the forward and rearward direction, since light from the outside hits the display sheet only from a forward direction, it is difficult for the light to reach a rear display sheet, and the rear display sheet, rather than the front display sheet, tends to be poorly illuminated, and this causes a problem in that the three-dimensional effect of the display sheet cannot be sufficiently expressed.

### SUMMARY OF THE INVENTION

A first object of the present invention is to provide a three-dimensional display device having the following characteristics:

(1) A combination of the display sheets, such as plural photographs and the like, can be enjoyed. In addition, the degree of freedom of the relative position of plural photographs is large and may be varied.

(2) The spacing between plural display sheets can be made large and the three-dimensional effect is excellent, while it can be constituted to be compact overall and the portability thereof is excellent.

A second object of the present invention is to provide a three-dimensional display device capable of brightly displaying a display sheet and gretly enhancing the three-dimensional effect, and at the same time,having superior design, and being compact overall, and yet being excellent in portability.

The three-dimensional display device according to one aspect of the present invention is a three-dimensional display device which can hold display sheets such as plural photographs, picture postcards, and the like, and can three-dimensionally dispose plural display sheets, and the display device includes a frame capable of holding the display sheet and plural support portions which are held by the frame and have a support surface to support the display sheet, wherein the frame can hold the support portions which are spaced apart and superposed in the forward and rearward direction, and the support surface of the support portion except for at least the rearmost portion is constituted by the surface of a transparent thin board.

According to the above-described aspect of the present invention, the display sheet such as the photograph and the like is supported on the support surface of each support portion, and respective support portions are separated back and forth by the frame, and are superposed and held. Accordingly, a combination of the display sheets can be enjoyed. For example, the rearmost support portion is allowed to support a background photograph, a background picture postcard and the like, and the support portion except for the rearmost support portion is allowed to support a photograph, a cutout such as a picture and the like, and when these support portions are superposed, one's own work having a three-dimensional expanse can be created.

Since the display sheet is supported by the support surface of the support portion, the position supported by the support surface of each support portion is changed variously, so that a degree of freedom of the relative position of the front and rear display sheets can be made high.

Plural support portions are held by the frame, and at the same time, the support surface of the support portion except for at least the rearmost support portion is constituted by the surface of the transparent thin board, and the gap between the support portion and the adjacent support portion can be constituted by a hollow, that is, an empty space. Hence, the influence of refractivity can be eliminated, and at the same time, a spacious three-dimensional space can be constituted. Furthermore, the device can be made compact, and can be made excellent in portability. Needless to say, the support surface of the support portion of the rearmost support portion may be constituted by the surface of the transparent thin board.

The frame has a front face frame portion and a rear face frame portion in which respective one side edges are mutually coupled and the other side edges are open, and within the internal space formed in a state of closing the other side edges by these front face frame portion and rear face frame portion, the support portion may be spaced apart in the forward and rearward direction and held. In this case, the other side edge between the front face frame portion and the rear face frame portion is made open, so that the display sheet supported by each support portion can be exchanged or the position thereof can be changed.

In such a constitution, the front face frame portion and the rear face frame portion have a truncated pyramidal form, respectively, and a truncated pyramidal front face frame portion and rear face frame portion may be superposed so as to form the internal space. In this case, by superposing two truncated pyramidal forms, a spacious internal space can be defined despite an overall compact form.

Furthermore, the above-described plural support portions may be disposed at respective top faces of the truncated pyramidal front face frame portion and the rear face frame portion and between the above-described two top faces. In this case, each support portion can be spaced apart widely.

Furthermore, the above-described picture frame has plural grooves spaced apart back and forth in its internal edge with the grooves holding the support portions, and the support portion can be taken out from one side of the picture frame or the support portion can be inserted inside the groove. In this case, the support portion held by each groove is taken out from the groove, so that the display sheet supported by each support portion can be exchanged or the position thereof can be changed.

Furthermore, in such a constitution, the above-described picture frame may be constituted by plural frame members having a groove formed by an extrusion molding and a joint for coupling the end portions of the adjacent frame member. In this case, the frame member can be produced at once at a moderate price.

The above-described picture frame comprises plural frame portions mutually and flexibly joined so as to accordion, and each frame portion can support the support portion, respectively, and the support portion may be taken out from one side of the frame portion or the support portion may be insertable into the frame portion. In this case, the display sheet supported by each frame portion can be exchanged or the position thereof can be changed.

The above-described support portion may have a pair of support surfaces, and the display sheet may be insertable between a pair of the support surfaces. In this case, a pair of the support surfaces can be constituted by a surface opposed to a pair of thin boards.

Furthermore, in such a constitution, a pair of the support surfaces may be constituted by a surface opposed to a pair of thin boards. Furthermore, in this case, the whole can be constituted compact.

The three-dimensional display device according to another aspect of the present invention comprises a picture frame, and plural support portions which are held by the picture frame and have a support surface to support a display sheet, and the above-described picture frame can hold the support portions by spacing them apart in the forward and rearward direction and superposing them in the forward and rearward direction, and in the three-dimensional display device capable of disposing three-dimensionally plural display sheets, the picture frame has a pair of holding arm portions for holding two sides opposed to the support portion and a coupling portion for mutually coupling a pair of the holding arm portions at the rear side thereof, and between the coupling portion and the rearmost support portion, there are formed a space, and at least a part of the side other than supported by a pair of the holding arm portions is open outward.

According to the above-described other aspect of the present invention, since the outside light can be taken up from the side opened toward the outside of the support portion between the support portions spaced apart and disposed in the forward and rearward direction and between the coupling portion and the rearmost support portion, the display sheet supported by the support board can be brightly displayed using light from the outside.

Furthermore, since the picture frame has a simple and compact constitution comprising the coupling portion and a pair of holding arm portions, it is convenient for hand carrying and excellent in portability.

Furthermore, the design can also be improved by the picture frame comprising the coupling portion and a pair of holding arm portions.

The above-described coupling portion may be formed with an opening. In this case, since the outside light can be taken up even from the opening formed in the coupling portion, the display sheet supported by the support board can be brightly displayed using light from the outside.

At least a part of the picture frame may be constituted by a transparent material. In this case, since the outside light can be also allowed to enter from the part comprising the transparent material of the picture frame, the display sheet supported by the support board can be brightly displayed using light from the outside.

In front of the above-described support portion, a lens supported by a pair of the holding arm portions may be disposed. In this case, the display sheet can be displayed by the lens to appear to have a depth, and the three-dimensional effect thereof can be improved.

A pair of the holding arm portions may be disposed vertically. In this case, since both side portions of the support portion can be opened outward, and since the outside light can be also allowed to enter from both side portions, the display sheet supported by the support board can be brightly displayed using light from the outside.

The above-described coupling portion may have a concavely flexible form for the rearmost support portion. In this case, a large space can be formed between the coupling portion and the rearmost support portion and much more outside light can be allowed to enter, and therefore, the display sheet supported by the support board can be brightly displayed using light from the outside.

Furthermore, the design can be improved by the curve-shaped coupling portion.

### BRIEF DESCRIPTION OF THE DRAWINGS

FIG. 1 is an overall oblique view showing a three-dimensional display device of a first embodiment according to an aspect of the present invention;

FIG. 2 is a cross sectional view taken along line A-A in FIG. 1;

FIG. 3 is an oblique view showing an open state of a front face frame portion and a rear face frame portion of the three-dimensional display of the first embodiment;

FIG. 4 is an oblique view showing a partly opened state of a front face frame portion and a rear face frame portion of the three-dimensional display of the first embodiment;

FIG. 5 is a rear view of the three-dimensional display device of the first embodiment;

FIGS. 6A, 6B, and 6C are oblique views showing an example of steps for forming a frame member of the front face frame portion and the rear face frame portion of the three-dimensional display device of the first embodiment by using a cardboard core;

FIG. 7 is an oblique view showing an example of display sheets three-dimensionally disposed inside the three-dimensional display device of the first embodiment;

FIG. 8 is a cross sectional view, similar to that in FIG. 2, of a three-dimensional display device of a second embodiment according to an aspect of the present invention;

FIG. 9 is an oblique view showing a fully opened state of a front face frame portion and a rear face frame portion of a three-dimensional display device of the second embodiment;

FIG. 10 is an oblique view showing an intermediate support portion removed from the three-dimensional display device of the second embodiment;

FIG. 11 is an overall oblique view showing a three-dimensional display device of a third embodiment according to an aspect of the present invention;

FIG. 12 is an overall oblique view showing a state of an upper side frame member of a three-dimensional display device of a third embodiment partially removed;

FIG. 13 is a partially broken oblique view of the three-dimensional display device of the third embodiment of FIG. 11;

FIG. 14 is an oblique view seen from the rear side of the three-dimensional display device of the third embodiment;

FIG. 15 is an oblique schematic illustration showing the display sheet and the support portion three-dimensionally displayed inside the three-dimensional display device of the third embodiment;

FIG. 16 is an overall oblique view showing a three-dimensional display device of a fourth embodiment according to an aspect of the present invention;

FIG. 17 is an overall oblique view showing an extended state of each frame portion of the three-dimensional display device of the fourth embodiment;

FIG. 18 is a schematic illustration showing a three-dimensional display device of a fifth embodiment according to another aspect of the present invention;

FIG. 19 is a schematic illustration showing a state of use of the three-dimensional display device of the fifth embodiment in FIG. 18 while holding display sheets;

FIG. 20 is a side view showing the three-dimensional display device of the fifth embodiment of FIG. 18;

FIG. 21 is an oblique view showing an example of display sheets and support boards three-dimensionally disposed inside the three-dimensional display device of the fifth embodiment;

FIG. 22 is a schematic illustration showing a three-dimensional display device of a sixth embodiment according to another aspect of the present invention seen from the rear;

FIG. 23 is a schematic illustration showing a three-dimensional display device of a seventh embodiment according to another aspect of the present invention;

FIG. 24 is a cross sectional view along a central vertical line of the three-dimensional display device of the seventh embodiment of FIG. 23;

FIG. 25 is a schematic illustration showing a three-dimensional display device of an eighth embodiment according to another aspect of the present invention;

FIG. 26 is a schematic illustration showing a three-dimensional display device of a ninth embodiment according to another aspect of the present invention;

FIG. 27 is a cross sectional view along the central vertical line showing a three-dimensional display device of a tenth embodiment according to another aspect of the present invention; and

FIG. 28 is a schematic illustration showing a three-dimensional display device of a eleventh embodiment according to another aspect of the present invention.

### DETAILED DESCRIPTION OF THE PREFERRED EMBODIMENTS

Embodiments of the present invention will be described below with reference to the drawings. It is to be expressly understood, however, that the invention is not limited to the following embodiments.

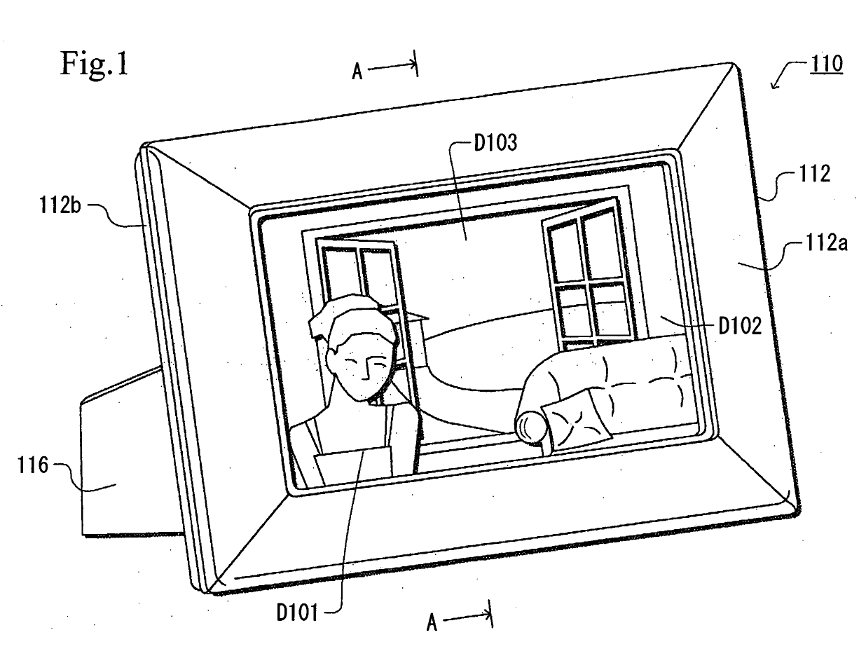

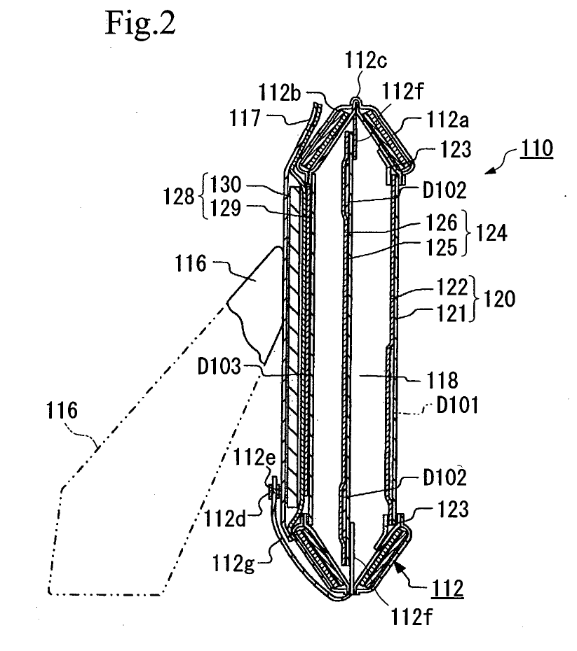

FIG. 1 is an overall oblique view showing a three-dimensional display device 110 of a first embodiment according to an aspect of the present invention. FIG. 2 is a cross sectional view taken along the line A-A in FIG. 1. In FIG. 1, the three-dimensional display device 110 includes a frame 112 which may be completely opened. The frame 112, as shown in FIGS. 2 to 5, is constituted by a front face frame portion 112a and a rear face frame portion 112b. The front face frame portion 112a and the rear face frame portion 112b are hinged and joined at the upper edges thereof, respectively, and are free at the lower side. The front face frame portion 112a and the rear face frame portion 112b are each in the shape of a square truncated pyramid overall.

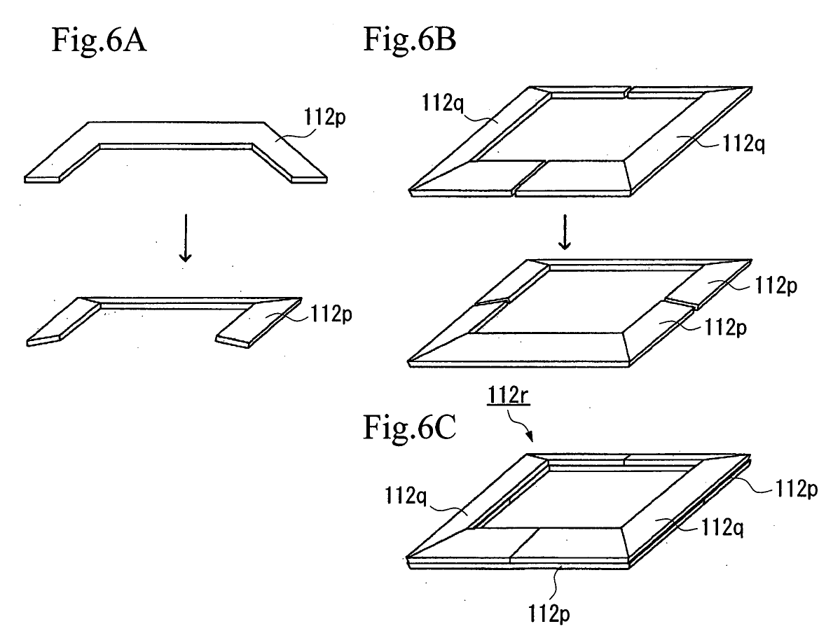

FIGS. 6A to 6C are oblique views showing an example of steps for forming a frame member 112r of the front face square truncated pyramidal frame portion 112a and the rear face square truncated pyramidal frame portion 112b by using a cardboard core. As shown in FIG. 6A, the cardboard is cut out in a wide spreading letter U shape, and it is made into a more three-dimensional form by bending it at the angled portions. In the case in which the bottom face of the square truncated pyramidal frame portion 112r is rectangular, as shown in FIG. 6B, two types of letter-U shaped members 112p and 112q having a base corresponding to a long side and a short side of the rectangle are prepared in two pieces each. When these members are superposed and adhered to each other as shown in FIG. 6C, they can be turned into the double square truncated pyramidal frame member 112r. The force with which the upper or lower letter-U shaped member returns to its original wide out shape is opposed by the base of an opposite side letter-U shaped member, and as a result, the double square truncated pyramidal shape of the frame member 112r is maintained.

However, the double square truncated pyramidal frame member 112r thus formed need not be of a cardboard, and it may also be a plastic molded component comprising a rigid plastic material. Furthermore, it may also be constituted by a wood, a paper or a metal material.

After having formed two pieces of the frame member (frame material) 112r having a square truncated pyramidal shape in this way, they are each covered with a synthetic resin sheet, and an outer edge and an internal edge are welded together with a high-frequency (for example ultrasonic) welder or the like, thereby forming the front face frame portion 112a and the rear face frame portion 112b, respectively. Furthermore, oppsite edges of the front face frame portion 112a and the rear face frame portion 112b are mutually welded by the high-frequency welder or the like, thereby forming a hinged coupling portion 112c.

In this way, with the hinged coupling portion 112c as a center, the front face frame portion 112a and the rear face frame portion 112b are closable and openable, and when a first coupling portion 112d as a snap button provided in a tongue portion 112g mounted on the front face frame portion 112a is joined with a second coupling portion 112e as a snap button provided on a rear cover 130 (described below), as shown in FIG. 2, the bottom faces of two pieces of the square truncated pyramidal front face frame portion 112a and rear face frame portion 112b are superposed, and a large internal space 118 is formed in an opposed state of these square truncated pyramidal front face frame portion 112a and rear face frame portion 112b. In the large internal space 118, there are provided plural support portions (a front support portion 120, an intermediate support portion 124, and a rear support portion 128) mutually spaced apart.

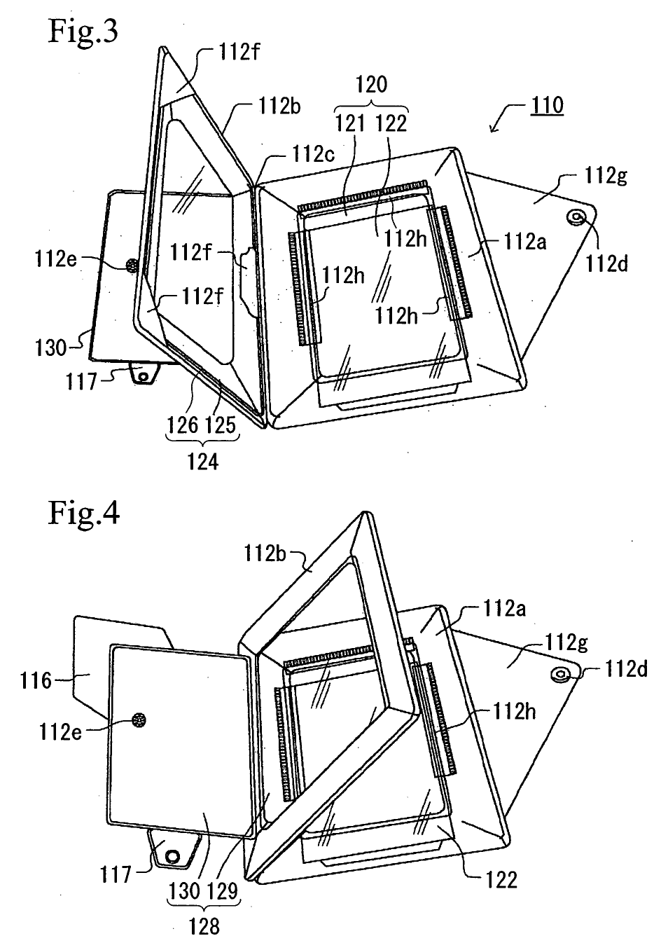

As shown in FIG. 3, the front support portion 120 for holding a display sheet such as a photograph and the like is held in the internal edge vicinity of the front face frame portion 112a. The front support portion 120 includes a pair of plastic transparent thin boards 121 and 122. The transparent thin board 121 has its entire peripheral edge welded to an internal peripheral edge of the front face frame portion 112a, and is adhered across an internal edge of the front face frame portion 112a. The other transparent thin board 122 is slidably held by the transparent thin board 121 by a guide piece 112h welded to three sides of the internal edge of the front face frame portion 112a.

As shown in FIG. 3, three pockets 112f are mounted in the outside edge vicinity of the rear face frame portion 112b. The intermediate support portion 124, for inserting the display sheet such as a photograph and the like, is held by the three pockets 112f. The intermediate support portion 124 includes a pair of plastic transparent thin boards 125 and 126. The angle portion and the sides of both the transparent thin boards 125 and 126 are inserted into the corresponding pocket 112f, respectively.

Furthermore, as shown in FIG. 4, a rear support portion 128 for inserting the display sheet such as a photograph and the like is held in the internal edge vicinity of the rear face frame portion 112b. The rear support portion 128 includes a transparent thin board 129 and a rear cover 130. The transparent thin board 129 has its entire peripheral edge welded to an internal peripheral edge of the rear face frame portion 112b, and is adhered across an internal edge of the rear face frame portion 112b. The rear cover 130 is hinged and joined to the rear surface of the rear face frame portion 112b, and is mounted so as to be closable and openable.

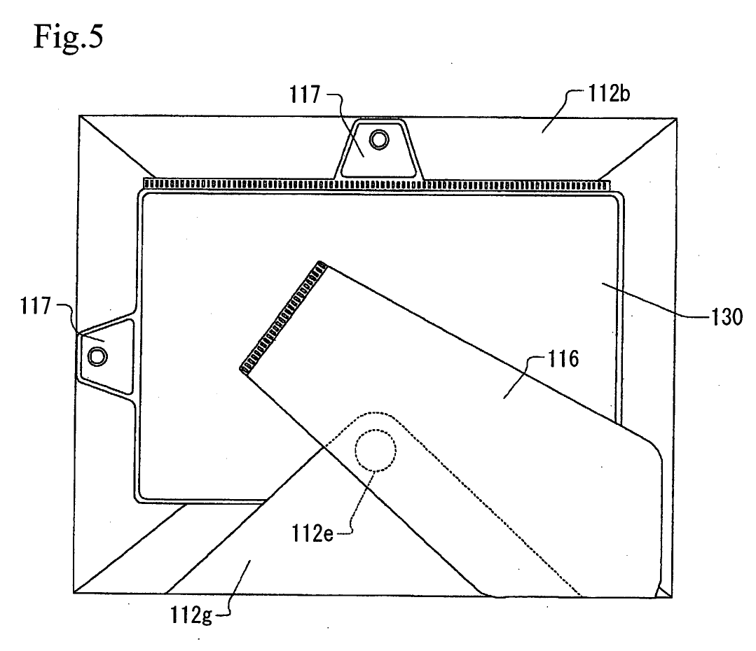

Furthermore, as shown in FIG. 5, a leg 116 for standing this three-dimensional display device 110 is hinged and joined to the rear surface of the rear cover 130. The leg 116, as shown in FIG. 5, has its coupling portion inclined, and this allows the three-dimensional display device 110 to stand up in either a horizontal or a vertical orientation. Furthermore, a catch-on hook portion 117 is welded to the device.

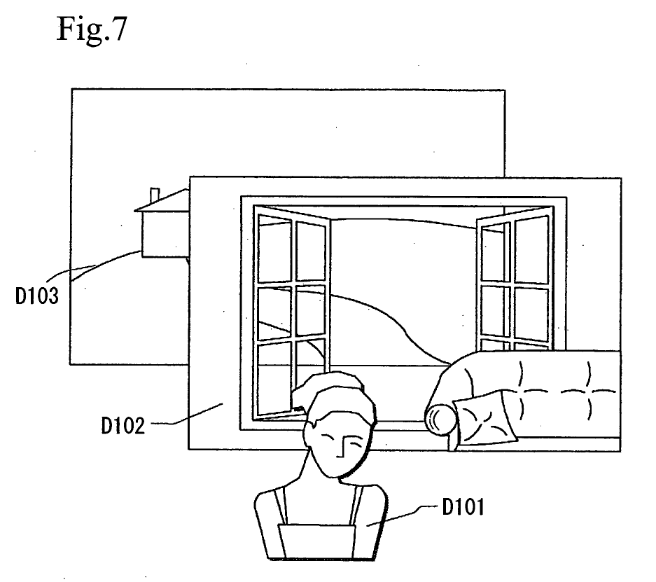

In the three-dimensional display device 110 constituted as described above, the display sheets D101, D102, and D103 such as a photograph and the like as shown in FIG. 7, are inserted respectively into the front support portion 120, the intermediate support portion 124, and the rear support portion 128 and are supported.

One example of the method for supporting these display sheets D101, D102, and D103 will be described below. As shown in FIGS. 3 and 4, the coupling of a first coupling portion 112d and a second coupling portion 112e is released, and then, in a wide open state of the front face frame portion 112a and rear face frame portion 112b, the display sheet D101 is inserted between the transparent thin boards 121 and 122 of the front support portion 120, and the display sheet D102 is inserted between the transparent thin boards 125 and 126 of the intermediate support portion 124, and the display sheet D103 is inserted between the transparent thin board 129 of the rear support portion 128 and the rear cover 130.

After having set the display sheets D101, D102, and D103 to the respective corresponding support portions, the first coupling portion 112d and the second coupling portion 112e are joined. In this way, the front face frame portion 112a and the rear face frame portion 112b are closed so as to define the internal space 118, and at the same time, the rear cover 130 is also replaced into a closed state. Consequently, the support portions (the front support portion 120, the intermediate support portion 124, and the rear support portion 128) are spaced apart in the forward and rearward direction and are superposed in the forward and rearward direction so as to be held within the internal space 118, and the display sheets D101, D102, and D103 inserted into each support portion are also held so as to be spaced apart within the internal space 118.

In this way, the display sheets D101, D102, and D103 can be three-dimensionally disposed, and can be three-dimensionally appreciated.

A combination of the display sheets D101, D102, and D103 can be chosen freely by the user, and a position for inserting the display sheets into the corresponding support portion can also be chosen freely by the user. For example, the display sheet D103 to be inserted into the rearmost portion can be a background, and the display sheet D101 to be inserted into the foremost portion can be a portrait of a character and a picture cutout of one's own preference. The display sheet D102 to be inserted into the intermediate portion can also be according to one's own preference, and as illustrated (in FIG. 7), it can be a picture of a window three-dimensionally connecting the space between the background and the cutout.

In this way, the combination of the display sheets can be enjoyed.

Alternatively, the display sheets D101, D102, and D103 may show a scene in time sequence, respectively so that a so-called “four-dimensional display sheet appreciation stand” with dimensions of depth and time, can be prepared.

Alternatively, any one of these display sheets D101, D102, and D103 can be disposed as if floating in space.

In the case in which it is desired that any or all of the display sheets D101, D102, and D103 be replaced or the position thereof be changed, the coupling of the first coupling portion 112d and the second coupling portion 112e is released, so that the display sheet inserted between two transparent thin boards of the corresponding support portion may be replaced or its position may be changed with other support portions remaining as they are. Hence, the operation is simple.

Incidentally, although the display sheets D101, D102, and D103 ought to be inserted between the transparent thin boards 121 and 122, between the transparent thin boards 125 and 126, and between the transparent thin board 129 and the rear cover 130, respectively, in the case in which the inserting force is not sufficient, it is possible to adhere the display sheet on the transparent thin board or the rear cover through a double-faced tape or an adhesive agent. Even in that case, it is possible to choose any adhering position inside the support surface formed by the transparent thin board or the rear cover.

In the present embodiment, although the front face frame portion 112a and the rear face frame portion 112b, which constitute the frame 112, have a square truncated pyramidal shape, respectively, they are not limited to this shape, and they can be any type of three-dimensional shape such as a circular truncated cone, a triangular truncated pyramid, a pentagonal truncated pyramid, a hexagonal truncated pyramid or an octagonal truncated pyramid and the like, or a circular cylinder, a triangular prism, a rectangular parallelepiped (square prism), a pentagonal prism, a hexagonal prism or an octagonal prism and the like.

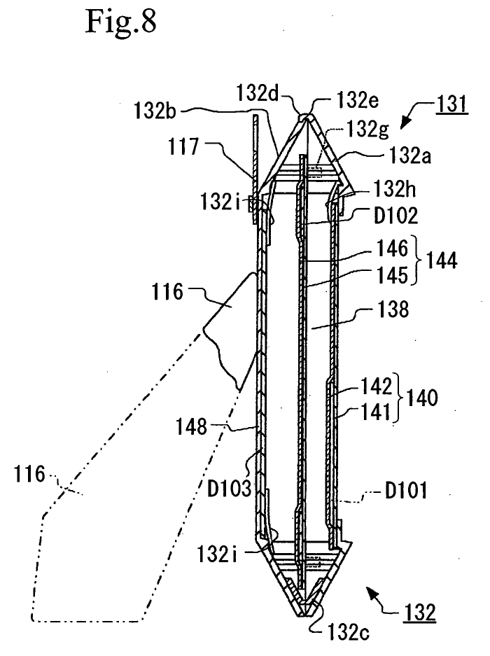

FIGS. 8 to 10 are views showing a three-dimensional display device 131 of a second embodiment according to an aspect of the present invention. In FIGS. 8 to 10, the three-dimensional display device 131 includes a frame 132 which is fully openable as in the first embodiment. The frame 132 can be constituted of a plastic molded component. In this embodiment, the frame 132 is constituted by a square truncated pyramidal front face frame portion 132a and rear face frame portion 132b, and the front face frame portion 132a and the rear face frame portion 132b are mutually hinged and joined by a coupling fixture 132c. The front face frame portion 132a and the rear face frame portion 132b are closable and openable with a hinge coupling portion therebetween. A hooked coupling portion 132d formed on the peripheral edge of the front face frame portion 132a is fittable to a notched coupling portion 132e formed on the peripheral edge of the rear face frame portion 132b. Furthermore, concave portions 132f are formed, respectively, in the vicinity of the four corners of the front face frame portion 132a, and convex portions 132g corresponding to the concave portions 132f are formed in the vicinity of the four corners of the rear face frame portion 132b.

When the hooked coupling portion 132d and the notched coupling portion 132e are joined, the convex portion 132g is fitted into the concave portion 132f, and similarly to the first embodiment, two square truncated pyramidal bottom faces are superposed, and a large internal space 138 is formed when these square truncated pyramids are opposed to each other. In the large internal space 138, there are provided plural support portions (a front support portion 140, an intermediate support portion 144, and a rear support portion 148) mutually spaced apart.

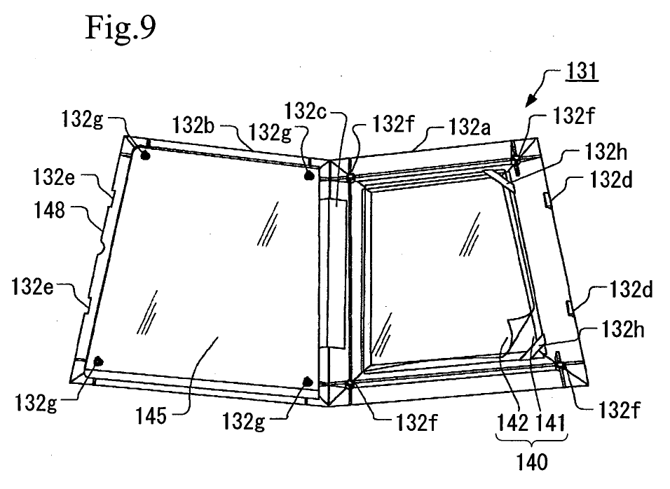

As shown in FIGS. 8 and 9, the front support portion 140 for inserting the display sheet D101 is held in the internal edge vicinity of the front face frame portion 132a. The front support portion 140 includes a pair of plastic transparent thin boards 141 and 142. The transparent thin board 141 has its entire peripheral edge welded to an internal peripheral edge of the front face frame portion 132a, and is adhered across an internal edge of the front face frame portion 132a. The other transparent thin board 142 has its lower end edge fixed to the lower end edge of the transparent thin board 141, and has its upper end edge pressed by presser pieces 132h and 132h.

As shown in FIGS. 8 and 9, the intermediate support portion 144 for inserting the display sheet D102 is held in the outer edge vicinity of the rear face frame portion 132b. The intermediate support portion 144 includes plastic transparent thin boards 145 and 146, in which one end edge thereof is mutually fixed, and a hole into which the convex portion 132g penetrates is formed at each of the four corners of these boards. The convex portion 132g is fitted into the concave portion 132f, so that the transparent thin boards 145 and 146 are fixed in the base portion of the convex portion 132g.

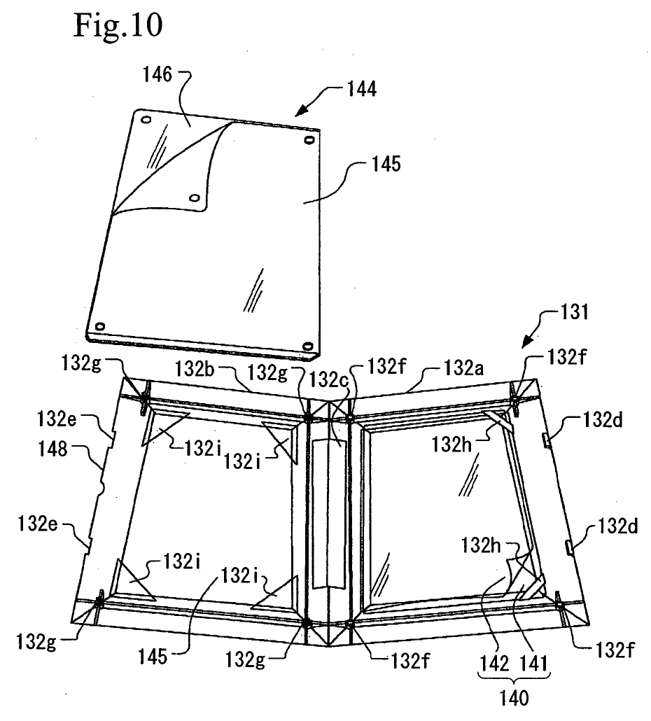

Furthermore, as shown in FIGS. 8 and 10, the internal edge portion of the rear face frame portion 132b is a rear cover 148 integral with the rear face frame portion 132b, and this rear cover 148 serves as a rear support portion (hereinafter, the rear cover 148 is referred to as the rear support portion) for supporting the display sheet D103. Pockets 132i are mounted, respectively, in the vicinity of the four corners of the rear cover 148, and a part of the display sheet D103, such as a photograph and the like, may be inserted into these four pockets 132i.

Even in the embodiment constituted as described above, the same operation and effects as those of the first embodiment can be obtained, and the display sheets D101, D102, and D103 can be three-dimensionally disposed and three-dimensionally appreciated. In the case in which it is desired that any one or all of the display sheets D101, D102, and D103 be replaced or the position thereof be changed, the coupling of the hooked coupling portion 132d and the notched coupling portion 132e is released, so that the display sheets supported by the corresponding support portions (the front support portion 140, the intermediate support portion 144, and the rear support portion 148) may be replaced or the positions thereof are changed. At this time, when the display sheet D103 is replaced or its position is changed, it is necessary to remove the transparent thin boards 145 and 146 which are the intermediate support portion 144. These boards have one end edge each mutually fixed, and can be integrally removed from the convex portion 132g without affecting the display sheet D102.

As described in the first and second embodiments, specific constitutions of the support portions for supporting the display sheets are possible in various forms, and can adopt any suitable constitution.

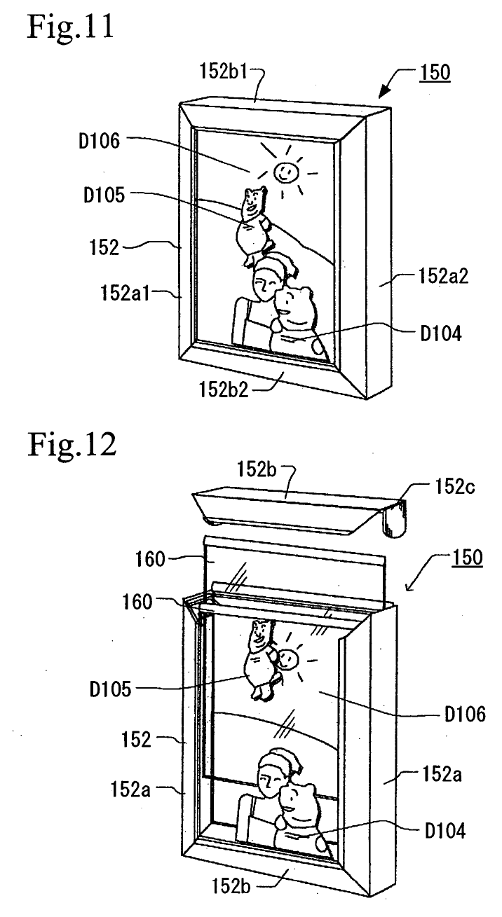

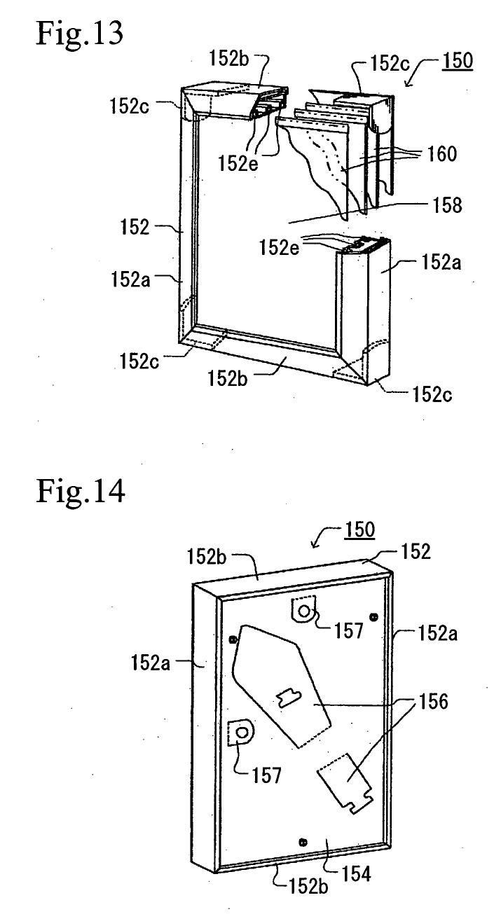

FIG. 11 is an overall oblique view showing a three-dimensional display device 150 of a third embodiment according to an aspect of the present invention. In FIG. 11, the three-dimensional display device 150 includes a frame 152. The frame 152 is constituted by four frame members 152a₁, 152a₂, 152b₁, and 152b₂, and an angle portion joint 152c (refer to FIG. 13), mutually connects the end portion of the adjacent frame members 152a₁, 152a₂, 152b₁, and 152b₂. As shown in FIG. 13, the cross sectional shape of each frame member 152a₁, 152a₂, 152b₁, and 152b₂ is the same, and these members can be produced by an extrusion molding at one time at a moderate cost. The angle portion joint 152c is L shaped, and its one end portion is inserted into the end portion of the frame member 152b, so that the adjacent frame members 152a and 152b are mutually joined.

The rear panel 154 is stretched over the entire rear of the frame 152 across the entire rear of the frame 152, and the rear panel 154 is fixed to the frame members 152a₁, 152a₂, and 152b₂ except for the upper side frame member 152b₁ by screws. In the rear panel 154, as shown in FIG. 14, there is integrally formed component parts to form a leg 156 before using, which is partially detachable from other component parts. The partial detaching and assembling of the component parts constitutes the leg 156. This leg 156 allows the three-dimensional display device 150 to stand up either horizontally or vertically. Furthermore, a catch-on hook portion 57 is integrally formed similarly for the rear panel 154 with one portion thereof isolatable.

As shown in FIG. 13, the frame members 152a₁, 152a₂, 152b₁ and 152b₂ and the rear panel 154 define an internal space 158 inside the frame 152.

Plural grooves 152e are formed in the internal edge of each frame member 152a₁, 152a₂, 152b₁ and 152b₂, and a support portion 160 is inserted into each groove 152e.

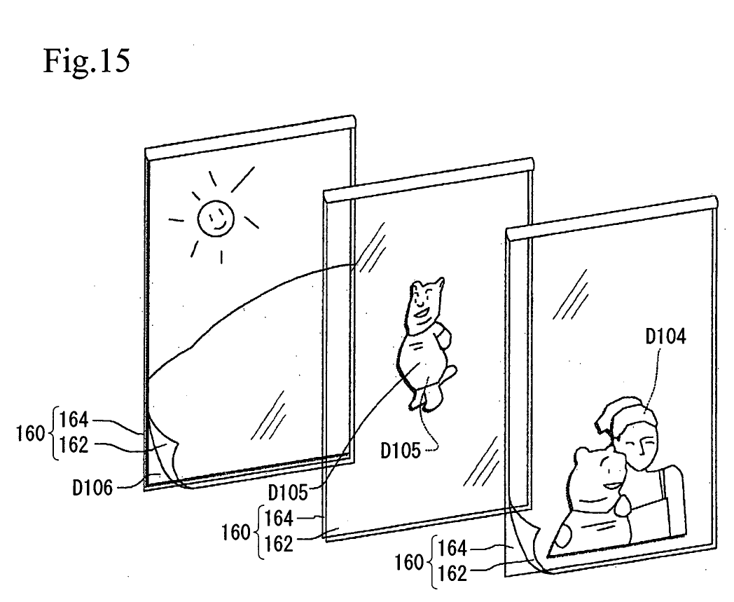

Each support portion 160, as shown in FIG. 15, includes two pieces of plastic transparent thin boards 162 and 164, and these transparent thin boards 162 and 164 are mutually joined at the upper end edge, and the display sheets D104, D105, and D106 can be inserted between these thin boards.

In the three-dimensional display device 150 constituted as described above, as shown in FIG. 12, the upper side frame member 152b is removed, and the upper side (one side) of the internal space 158 of the frame 152 is free. After that, plural support portions 160 which are fitted into each groove 152e are removed, and the desired display sheets D104, D105, and D106 are inserted into the transparent thin boards 162 and 164 of these support portions 160. After that, the support portions 160 are inserted into the grooves 152e again, and the upper side angle portion joint 152c is mounted from above. In this way, each support portion 160 is spaced apart in the forward and rearward direction and is superposed inside the internal space 158 in the forward and rearward direction, and the display sheets D104, D105, and D106 inserted in each support portion 160 are also held in a spaced apart state in the internal space 158.

In this way, the display sheets D104, D105, and D106 can be three-dimensionally disposed and can be three-dimensionally appreciated.

Furthermore, in the case in which it is desired that any one of the display sheets D104, D105, and D106 be replaced or the position thereof be changed, the upper side frame 152b is removed, and the corresponding support portion 160 is removed, so that the display sheet is preferably replaced or the position thereof is preferably changed, and since other support portions remain as they are, the operation thereof is simple.

Incidentally, although the display sheets D104, D105, and D106 should be inserted between the transparent thin board 162 and the transparent thin board 164, in the case in which the inserting force is not sufficient, it is possible to adhere the display sheet on the transparent thin board 162 or the transparent thin board 164 through a double-faced tape or an adhesive agent. Even in that case, it is possible to choose any adhering position inside the support surface formed by transparent thin boards 162 or 164.

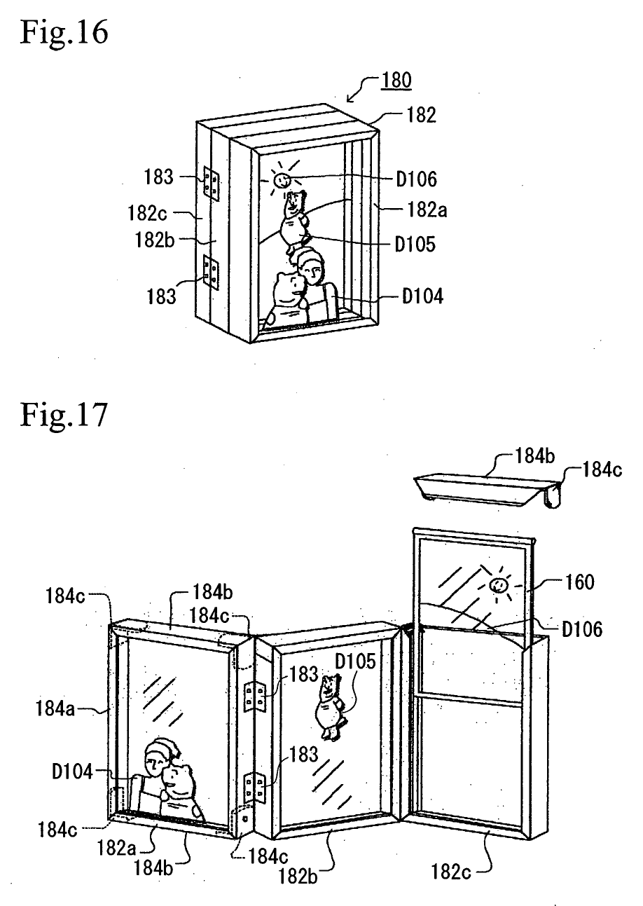

FIG. 16 is an overall oblique view showing a three-dimensional display device 180 of a fourth embodiment according to an aspect of the present invention. In FIG. 16, the three-dimensional display device 180 includes a frame 182. The frame 182 is constituted by a front face frame portion 182a, an intermediate frame portion 182b, and a rear face frame portion 182c, and respective frame portions are hinged and joined by hinges 183 and 183, and are mutually and flexibly joined so as to accordion. When each frame portion 182a, 182b, and 183c is mutually extended, as shown in FIG. 17, the front face frame portion 182a, the intermediate frame portion 182b, and the rear face frame portion 182c are aligned in a lateral direction.

The front face frame portion 182a, the intermediate frame portion 182b, and the rear face frame portion 182c have four sides constituted by frame members 184a and 184b, respectively which can be formed at one time by an extrusion molding. The adjacent frame members 184a and 184b are joined by a L-shaped angle portion joint 184c. With respect of this coupling, since it is the same as that of the third embodiment, detailed description thereof will be omitted. In this embodiment, a piece of a support portion 160 is inserted into each frame portion 182a, 182b, and 182c. Consequently, by adjusting the thickness of each frame portion, the interval of each support portion 160 can be adjusted. When each frame portion 182a, 182b, and 182c is superposed in the forward and rearward direction so as to form a frame 182, in the internal space formed thereby, each support portion 160 is spaced apart in the forward and rearward direction by the thickness of the frame portions 182a, 182b, and 182c and superposed in the forward and rearward direction and held, and each display sheet D104, D105, and D106 inserted into each support portion 160 is also put into a spaced apart state and held, respectively in the internal space.

In this embodiment also, the same operation and effects as those of the above-described embodiments can be obtained.

Next, a three-dimensional display device according to another aspect of the present invention will be described below.

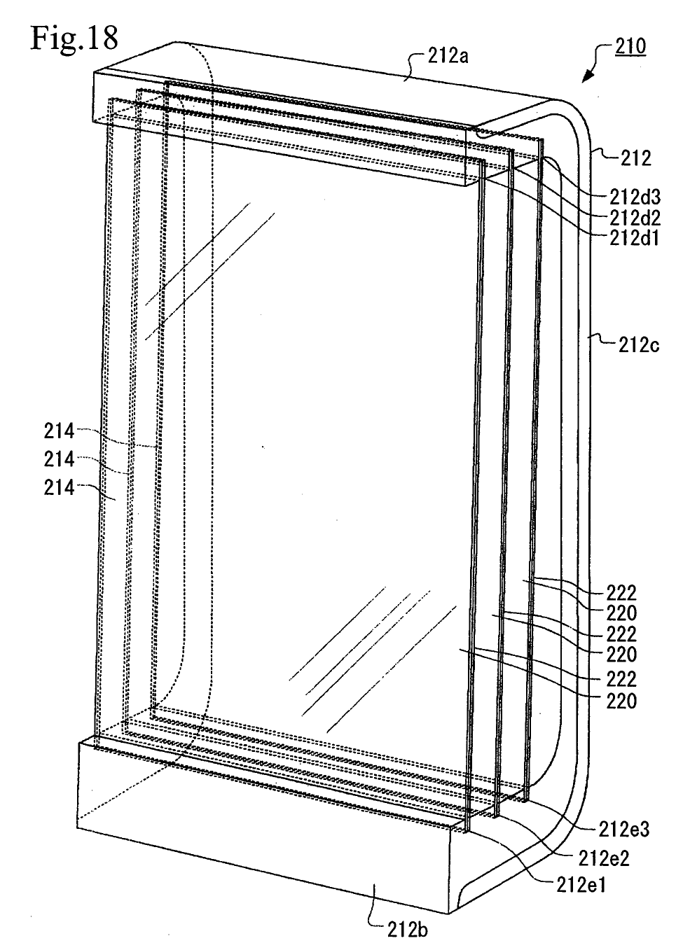

FIG. 18 is a schematic illustration showing a three-dimensional display device 210 of a fifth embodiment according to another aspect of the present invention. In FIG. 18, the three-dimensional display device 210 has a frame 212. This frame 212 includes a pair of holding arm portions 212a and 212b opposed to each other, and a coupling portion 212c mutually coupling these holding arm portions 212a and 212b at the rear thereof. Such a frame 212 can be formed of a material such as wood, paper, metal, plastic and the like. For example, in the case in which the frame 212 is formed by using a plastic material, it can be obtained by coupling two molded parts constituting a front portion and a rear portion.

The overall shape seen laterally of three portions of the holding arm portions 212a and 212b and the coupling portion 212c has nearly a U-shape. The two holding arm portions 212a and 212b are joined mutually only at the rear thereof by the coupling portion 212c, and are not joined at other portions.

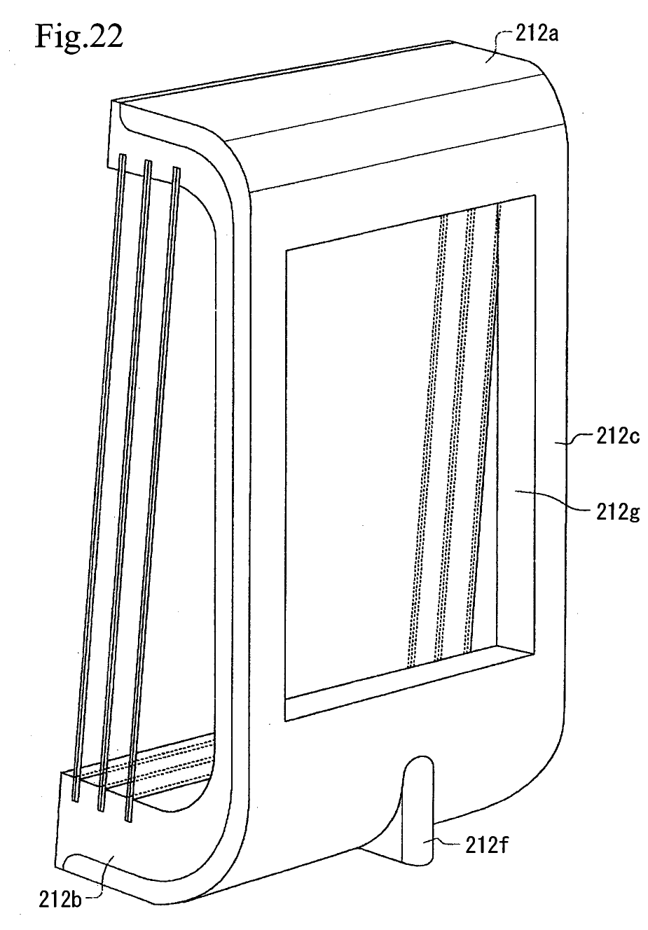

Furthermore, a leg 212f for standing is formed at the under part of the coupling portion 212c (refer to FIG. 22). However, when the three-dimensional display device is to be a wall hanging type, the leg 212f can be omitted.

On the surface portion opposed to the two holding arm portions 212a and 212b, there are formed plural (three pieces in the case of the present embodiment) grooves 212d (212d₁, 212d₂, and 212d₃) and 212e (212e₁, 212e₂, and 212e₃) in such a way as to mutually make a pair thereof, and 212d₁, 212d₂, and 212d₃ and 212e₁, 212e₂, and 212e₃ are spaced apart and disposed in the forward and rearward direction, respectively. In the present embodiment, it is assumed that the holding arm portion 212a is disposed above and the holding arm portion 212b is disposed below. Consequently, as shown in FIG. 20, the groove 212d of the holding arm portion 212a and the groove 212e of the holding arm portion 212b, which are to form a pair, do not match each other fully on a vertical line, but the groove 212e is positioned slightly more forward than the corresponding groove 212d. Furthermore, between the rearmost grooves 212d₃ and 212e₃ from among the grooves 212d and 212e and the coupling portion 212c, there is provided a space.

A support board 214 constituting the support portion is inserted into the grooves 212d and 212e, which are to form a pair. Since a pair of the grooves 212d and 212e are mutually spaced apart, plural support boards 214 are spaced apart in the forward and rearward direction and disposed.

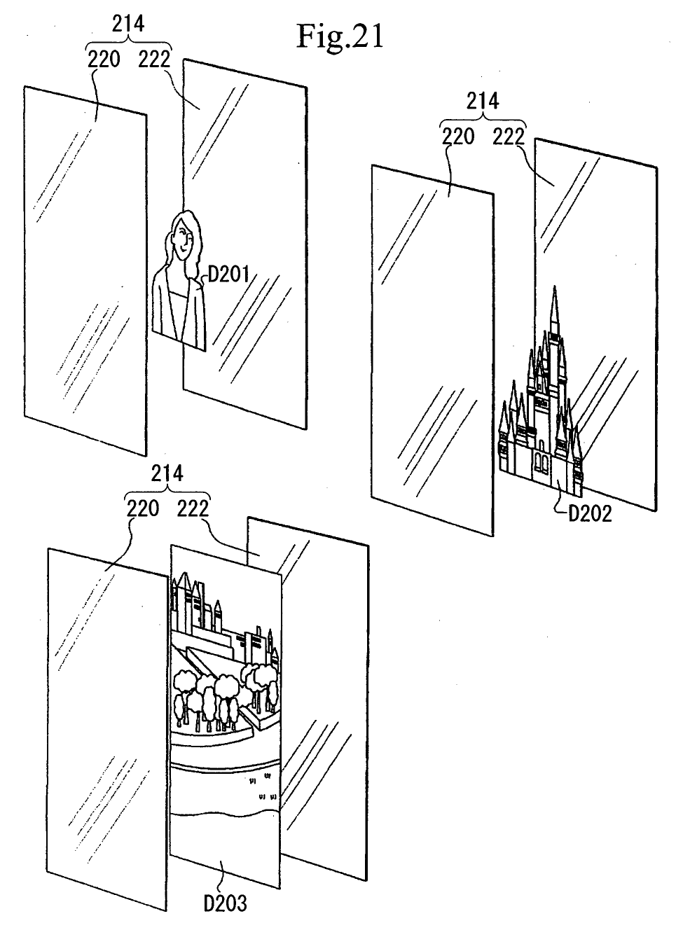

The support board 214, as shown in FIG. 21, includes two pieces of transparent thin boards 220 and 222, and the display sheets D201, D202 and D203 can be inserted between these transparent thin boards 220, and 222. However, the support board 214 can be a sheet of the transparent thin board. In this case, the display sheet may be adhered to the support board 214 by a double-faced tape or an adhesive agent. Furthermore, as the support board 214, a board on which a transparent flexible sheet is superposed on a transparent thin board is used, and the display sheets D201, D202, and D203 may be inserted between the transparent thin board and the transparent flexible sheet.

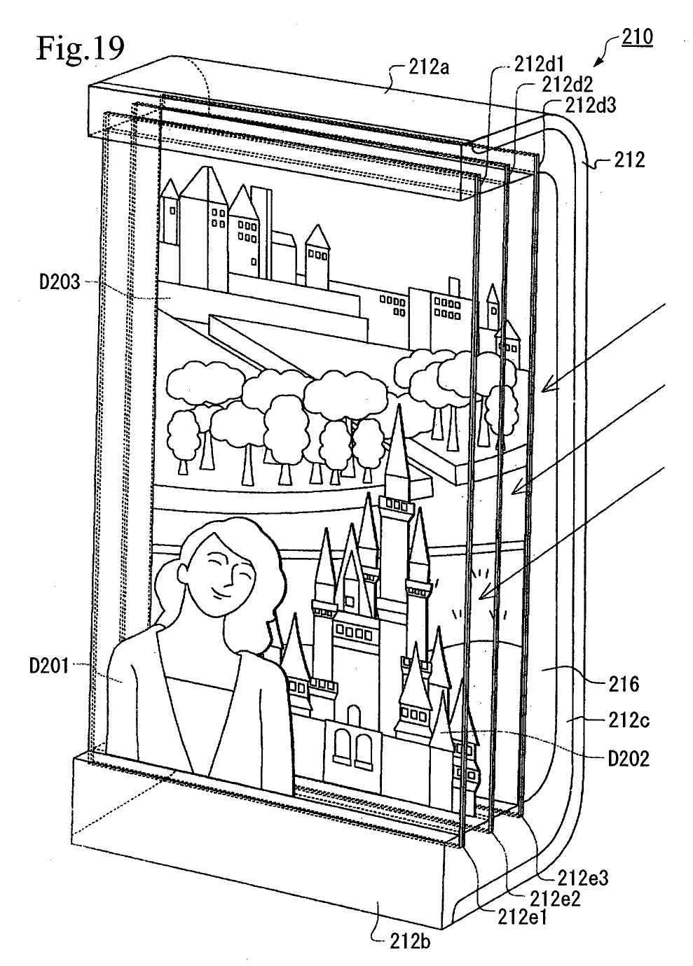

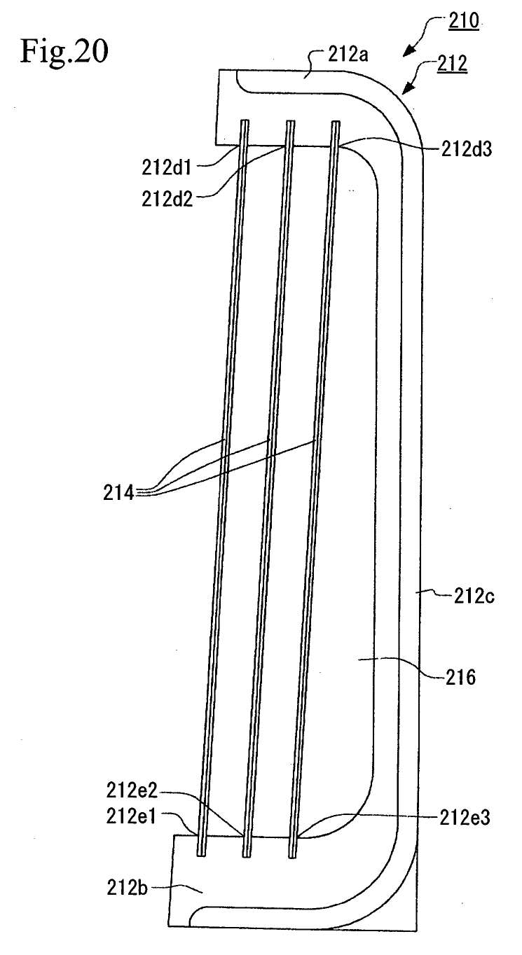

A combination of the display sheets D201, D202, and D203 can be chosen freely by the user, and a position for inserting the display sheets into the corresponding support portion can also be chosen freely by the user. For example, the display sheet D203, which is to be inserted into the rearmost portion, can be a background, and the display sheet D201, which is to be inserted into the foremost portion, can be a portrait of oneself or a character or a picture cutout according to one's preference. The display sheet D202, which is to be inserted into the intermediate portion, may be chosen as desired, and as illustrated, it can be a picture of something (a castle in the case of FIGS. 19 and 21) which connects three-dimensionally the space between the background and the cutout. In this way, a combination of the display sheets can be enjoyed.

Alternatively, the display sheets D201, D202, and D203 may show a scene in time sequence, respectively so that a so-called “four-dimensional display sheet appreciation stand”, with dimensions of depth and time, can be prepared.

In this fifth embodiment, the holding arm portions 212a and 212b hold only two sides opposed to the support board 214. That is, edges (end edges) of two sides other than those supported by the holding arm portions 212a and 212b of the support portion 214 are free outwardly. In this way, light from the outside can enter into the space of the support boards 214 spaced apart and disposed in the forward and rearward direction from the edges of both free ends of the support boards 214. At the same time, as shown in FIG. 19, since a space 216 is also formed between the rearmost support board 214 and the coupling portion 212c in the forward and rearward direction, light from the outside can also be allowed to enter into the rear of the rearmost support board 214. Consequently, the display sheets D201, D202, and D203 supported by each support board 214 can be displayed while well illuminated by light from the outside.

The setting or replacing of the display sheets D201, D202, and D203 can be performed by inserting and removing the corresponding support boards 214 from a free portion between the holding arm portions 212a and 212b as occasion demands. Consequently, inserting and removing the display sheets into and out of the grooves 212d and 212e of the holding arms 212a and 212b of the support board 214 can be simply performed.

When hand carrying the device, it can be hand carried by grasping the coupling portion 212c, and therefore, it is excellent in portability.

Since the frame 212 is not provided across the entire periphery of the four sides of the photograph similarly with a photographic frame, the device can be constituted compact with an excellent design, and the display sheets D201, D202, and D203 can be brought into clear view.

Furthermore, in a pair of the grooves 212d and 212e, since the groove 212e is positioned slightly forward than the groove 212d, the support board 214 can be held slightly inclined upward, thereby making the device into a three-dimensional display device suitable for an installation type. However, when this three-dimensional display device is turned into a wall hanging type, the position of the grooves 212d and 212e can be aligned in a vertical direction.

FIG. 22 is a schematic illustration showing a three-dimensional display device of a sixth embodiment according to another aspect of the present invention. The sixth embodiment is a modified embodiment of the three-dimensional display device 210 of the fifth embodiment in FIG. 18, and an opening 212g is formed in the coupling portion 212c. In this way, since more light from the outside can be admitted from the rear, the display sheets D201, D202, and D203 supported by each support board 214 can be further displayed brightly by the outside light.

As for the opening 212g, not only a large opening as illustrated, but also plural small openings or a grid-like opening may be chosen.

Furthermore, instead of providing the opening 212g as described above, at least a part of the holding arm portions 212a and 212b and the coupling portion 212c can be constituted by a transparent material.

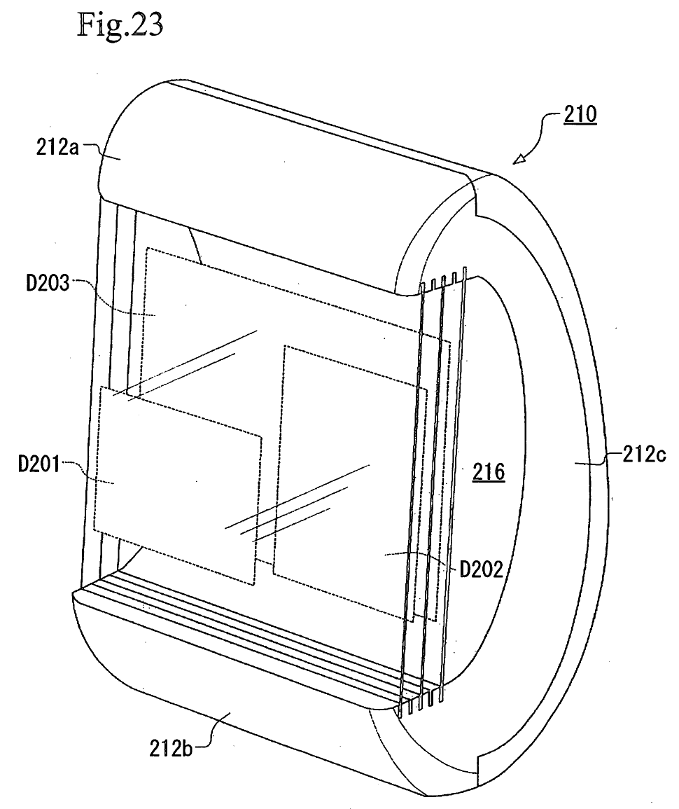

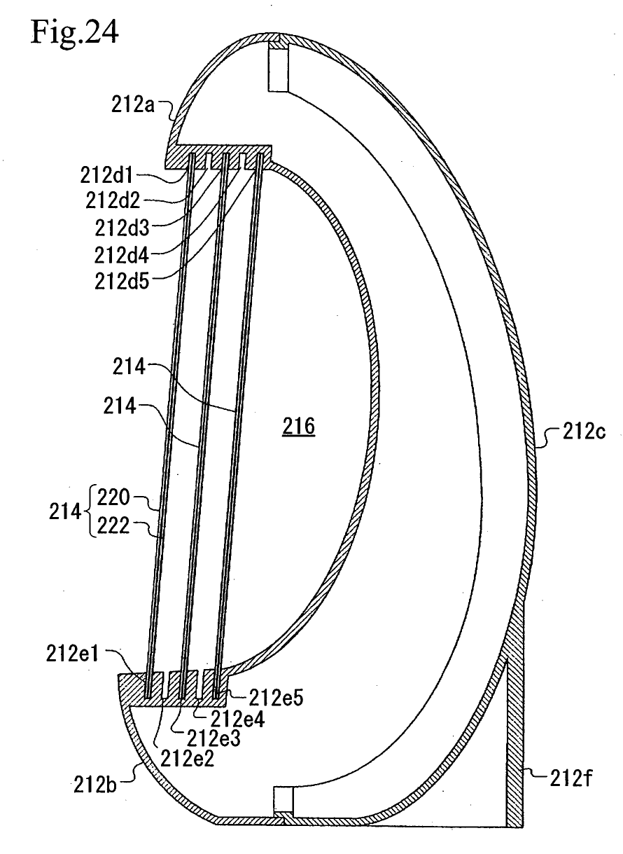

FIG. 23 is a schematic illustration showing a three-dimensional display device 210 of a seventh embodiment according to another aspect of the present invention, and FIG. 24 shows a cross sectional view thereof. In this seventh embodiment, a coupling portion 212c does not extend straight vertically as in the fifth and sixth embodiments, but is curved concavely for the support board 214. Consequently, between the curved coupling portion 212c and the rearmost supporting board 214, there is formed a large space 216, which is constituted such that the light from the outside can be admitted much more easily. Furthermore, the holding arm portions 212a and 212b are not rectangular in cross section as in the fifth and sixth embodiments, but are shaped like a quarter cylinder, and have a shape which is excellent in design overall.

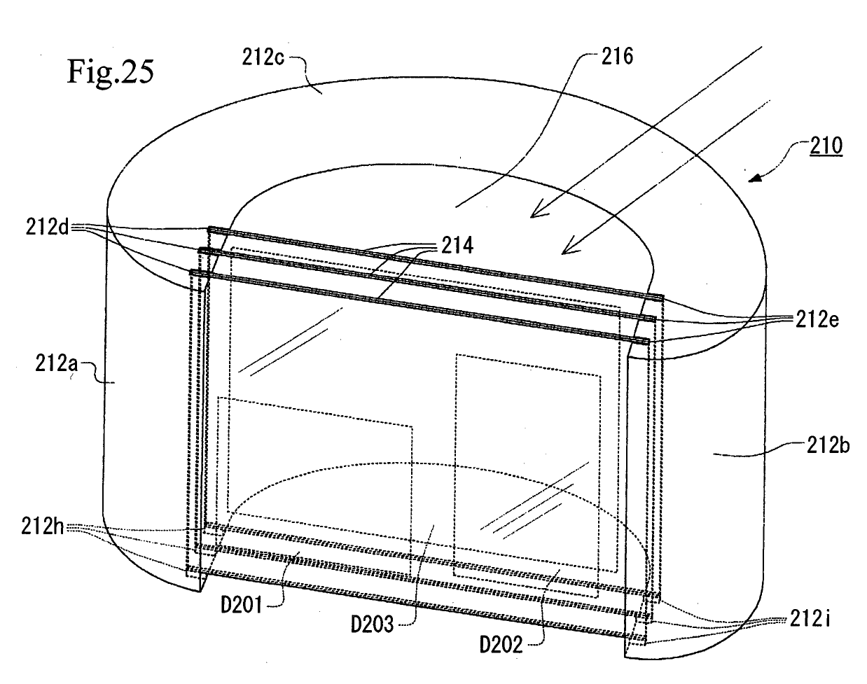

FIG. 25 is a schematic illustration showing a three-dimensional display device 210 of an eighth embodiment according to another aspect of the present invention. In this embodiment, a three-dimensional display device similar to that of FIG. 18 is disposed sideways, and holding arm 212a and 212b are disposed right and left, respectively.

A support board 214 is allowed to be inserted between grooves 212d and 212e from above. Consequently, sealing portions 212h and 212i are provided at one end (lower end in the case of FIG. 25) of the grooves 212d and 212e, and the sealing portions 212h and 212i hold the lower end of the support boards 214 and prevent the support board 214 from falling.

Even in the three-dimensional display device constituted as described above, light from the outside can enter into a space between support boards 214 spaced apart and be disposed from the free upper side of the support board 214. At the same time, the light from the outside can be admitted into the rear of the rearmost support board 214 from the space 216, and the display sheets D201, D202, and D203 supported by each support board 214 can be brightly displayed using the light from the outside.

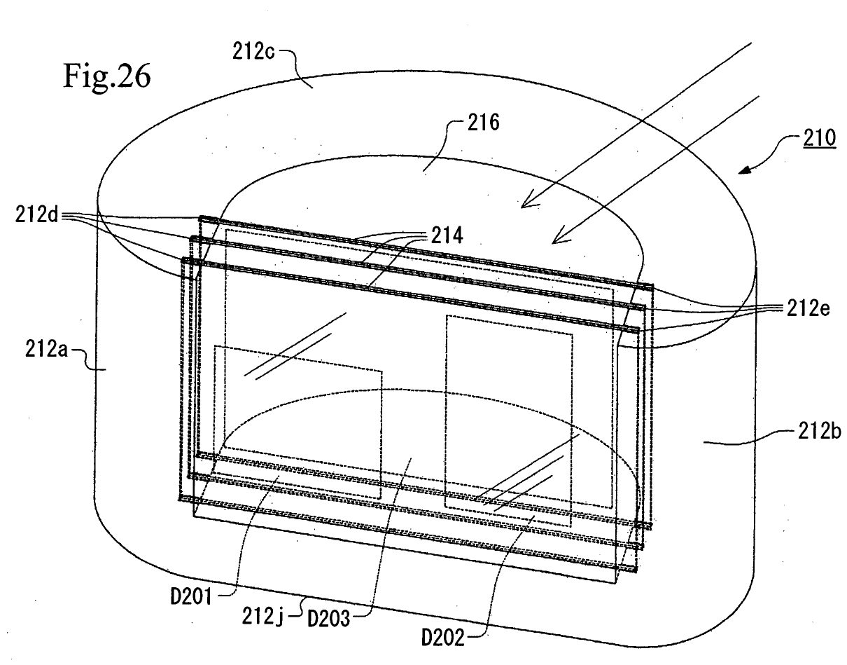

FIG. 26 is a schematic illustration showing a three-dimensional display device 210 of a ninth embodiment according to another aspect of the present invention. The ninth embodiment is a modified embodiment of the three-dimensional display device 210 of the eighth embodiment of FIG. 25. This embodiment differs from the other embodiments in having a bottom portion 212j. Even with the bottom portion 212j, the light from the outside can be admitted from above, and therefore, display sheets D201, D202, and D203 can be brightly displayed using the light from the outside.

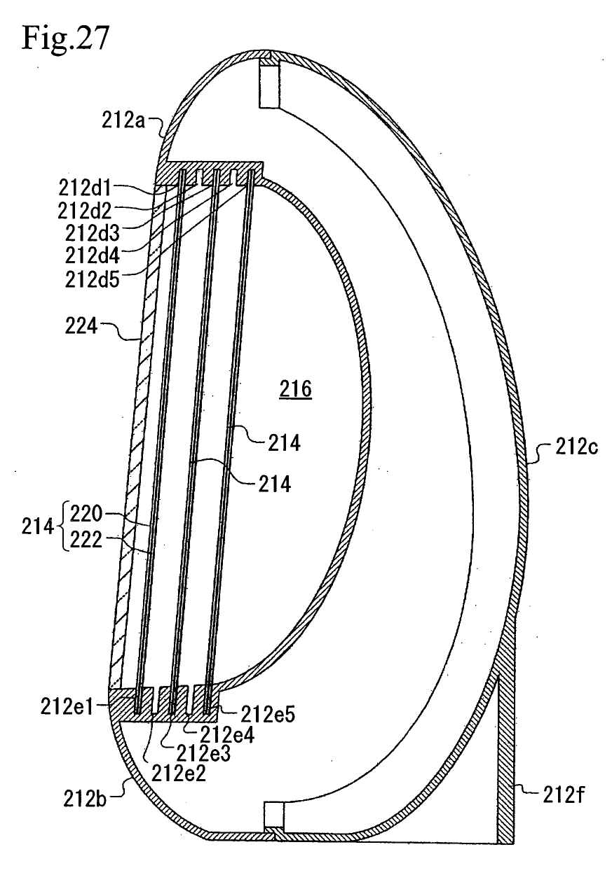

FIG. 27 is a cross sectional view along the central vertical line showing a three-dimensional display device of a tenth embodiment according to another aspect of the present invention. In the tenth embodiment, a lens 224 is provided in front of a support board 214. The lens 224 is disposed across a pair of holding arm portions 212a and 212b.

The lens 224 allows the display sheet to be displayed so as to have more depth, thereby improving a three-dimensional effect.

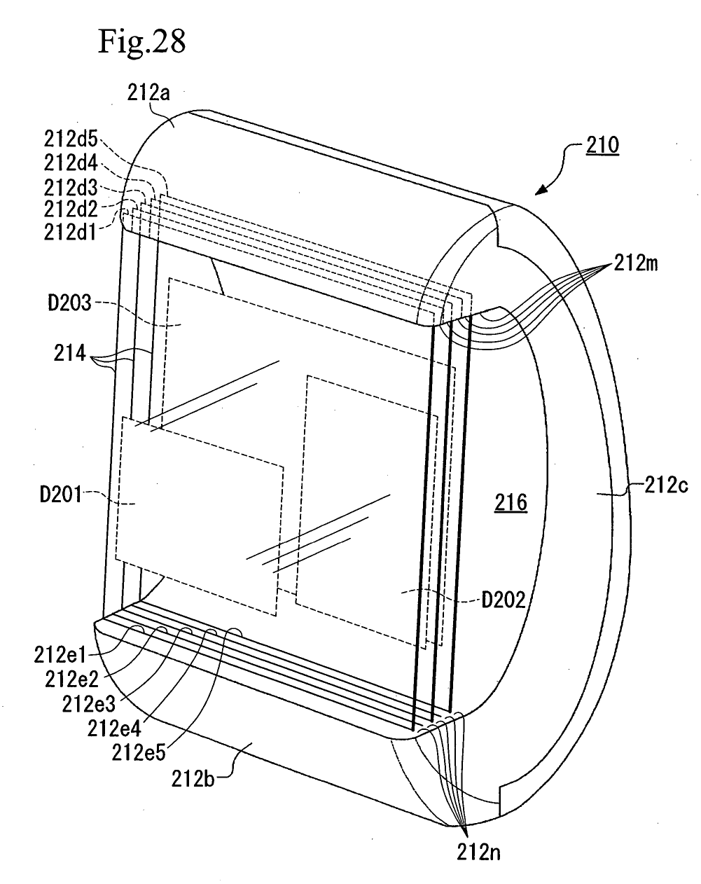

FIG. 28 is a schematic illustration showing a three-dimensional display device of a eleventh embodiment according to another aspect of the present invention. The eleventh embodiment is a modified embodiment of the three-dimensional display device 210 of the seventh embodiment in FIG. 23. On the surface portion opposed to the two holding arm portions 212a and 212b, there are formed a plurality (five pieces in the case of the present embodiment) of grooves 212d and 212e. Sealing portions 212m and 212n are provided at one end (right end in the case of FIG. 28) of the grooves 212d and 212e.

In this way, when the three-dimensional display device 210 is in the position that the one end of grooves 212d and 212e are facing downward, the sealing portions 212m and 212n hold the lower end of the support boards 214 and can prevent the support board 214 from falling. Therefore the three-dimensional display device 210 can be used in the position in which the one end of grooves 212d and 212e are facing downward.

In the above described first to eleventh embodiments, although each frame is provided respectively with three support portions, it is not limited to this, and two support portions or more than four support portions can be provided. According to each embodiment, even when there are plural support portions, since the shape as the frame can be made compact, the device is convenient for hand-carrying, and it may be hand carried for a visit, a business trip, and the like, and in addition, it can be used for souvenirs. Furthermore, the device may have multiple frames, and combined with the pictures and the like in the frames, various pattern variations of the display sheets and frames can be enjoyed.

Furthermore, as for the transparent thin board, which constitutes the support portions (for example, the front support portion and the intermediate support portion) except for the support portion (for example, the rear support portion) positioned at the rearmost (viewed from the front side of the frame), a Fresnel lens may be used. In this case, a picture, a pattern and the like positioned behind the Fresnel lens is magnified by the Fresnel lens, so that a better visual effect can be obtained. For example, a degree of freedom of relative position of plural photographs is further increased. Furthermore, by adequately adjusting a disposed position of the Fresnel lens, a picture pattern of the display sheet, a design and the like, the display sheet can be displayed so as to have a depth and a better three-dimensional effect.

While the preferred embodiments of the present invention have been described as above, it should be understood that the invention is not limited thereto, and the addition, the omission, the substitution, and other modifications of the constitution may be made without departing from the scope of the invention. It will be appreciated that the present invention is not restricted by the above-described explanations, but is restricted only by the scope of the accompanying claims.

The three-dimensional display device of the present invention can be enjoyed by combining the display sheets such as plural photographs and like. In addition, a degree of freedom of relative positions of plural photographs is high, and excellent in variation, and therefore, it can be used for a three-dimensional photo-stand, a display sheet appreciation stand for use of various displays and the like.

What is claimed is:

1. A three-dimensional display device comprising:
a frame; and
plural support portions held by the frame, the support portions for holding objects to be displayed.

2. The three-dimensional display device according to claim 1,
wherein said frame comprises a front face frame portion and a rear face frame portion.

3. The three-dimensional display device according to claim 1,
wherein said support portion comprises a transparent thin board.

4. The three-dimensional display device according to claim 2,
wherein an edge of the front face frame portion and an edge of the rear face frame portion are joined and other edges thereof are free.

5. The three-dimensional display device according to claim 4,
wherein said support portions are disposed apart and are held inside an internal space formed by the frame.

6. The three-dimensional display device according to claim 4,
wherein said front face frame portion and said rear face frame portion are each truncated pyramids.

7. The three-dimensional display device according to claim 6,
wherein bottom faces of the front face frame portion and rear face frame portion are joined so as to form an internal space.

8. The three-dimensional display device according to claim 6,
wherein said plural support portions are disposed between respective top faces of said front face frame portion and rear face frame portion and two top faces.

9. The three-dimensional display device according to claim 1,
wherein said frame has plural grooves spaced apart in the forward and rearward direction in its internal edge, and holds the support portion by said grooves, and said support portion can be removed from one side of the frame or the support portion can be inserted inside the grooves.

10. The three-dimensional display device according to claim 9,
wherein said frame comprises plural frame portions formed by an extrusion molding and a joint which mutually joins the end portion of adjacent frame members.

11. The three-dimensional display device according to claim 1,
wherein said frame comprises plural frame portions mutually and flexibly joined so as to accordion,
and each frame portion can support a support portion, and said support portion may be removed from the frame portion or the support portion may be inserted into the frame portion.

12. The three-dimensional display device according to claim 1,
wherein said support portion has a pair of support surfaces, and a display sheet can be inserted between said pair of support surfaces.

13. The three-dimensional display device according to claim 12,
wherein said pair of support surfaces is constituted by the surface opposed to a pair of thin boards.

14. A three-dimensional display device comprising:
a frame; and
plural support portions held by the frame, the support portions for holding objects to be displayed,
wherein said frame comprises a pair of holding arm portions for holding two sides opposed to the support portion and a coupling portion for mutually joining said pair of holding arm portions at the rear side.

15. The three-dimensional display device according to claim 14,
wherein a space is formed between the coupling portion and the rearmost support portion.

16. The three-dimensional display device according to claim 14,
wherein at least a part of the side of the support portion other than those supported by said pair of holding arm portions is free.

17. The three-dimensional display device according to claim 14,
wherein said frame is spaced apart and superposed in the forward and rearward direction so as to be able to support the support portion.

18. The three-dimensional display device according to claim 14,
wherein an opening is formed in said coupling portion.

19. The three-dimensional display device according to claim 14,
wherein at least a part of said frame comprises a transparent material.

20. The three-dimensional display device according to claim 19,
wherein said transparent thin board comprises a Fresnel lens.

21. The three-dimensional display device according to claim 14,
wherein a lens supported by said pair of holding arm portions is disposed in front of said support portion.

22. The three-dimensional display device according to claim 14,
wherein said pair of holding arm portions is disposed vertically.

23. The three-dimensional display device according to claim 14,
wherein said coupling portion is concavely curved for the rearmost support portion.
